(19) United States
(12) Patent Application Publication
(10) Pub. No.: US 2006/0280426 A1
(43) Pub. Date: Dec. 14, 2006

(54) METHOD FOR STORING AND REPRODUCING DATA AND COMMUNICATION TERMINAL AND SYSTEM FOR THE SAME

(76) Inventor: Jung Hyouk Kang, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 11/423,374

(22) Filed: Jun. 9, 2006

(30) Foreign Application Priority Data
Jun. 10, 2005 (KR) 10-2005-0049835

(51) Int. Cl. H04N 11/04

(52) U.S. Cl. 386/40

(57) ABSTRACT

A method, communication terminal and system for storing and reproducing multimedia broadcast stream data are provided. By converting the broadcast stream to a moving image file, reproduction of broadcast data by a mobile communication-only terminal that has no broadcast modem for multimedia broadcasts is facilitated by using a mobile communication modem.

### CROSS REFERENCE TO RELATED APPLICATION

This application claims the benefit of the Korean Patent Application No. 10-2005-0049835, filed on Jun. 10, 2005, which is hereby incorporated by reference as if fully set forth herein.

### FIELD OF THE INVENTION

The present invention relates to multimedia broadcasts, and more particularly, to a method, communication terminal and system for storing and reproducing stream data for multimedia broadcasts.

### DISCUSSION OF THE RELATED ART

Multimedia broadcasts have been introduced and implemented recently. Multimedia broadcasts can be defined as digital broadcasts that can provide audio, video and data services with high quality sound and images as well as high quality stationary and mobile reception.

Communication terminals that support multimedia broadcasts must not only have a modem for coding and decoding mobile communication data, but also a broadcast modem for decoding broadcast data. However, when a conventional communication terminal receives broadcast data and reproduces the received broadcast data at a later time, it is necessary for the communication terminal to store a large amount of the broadcast data that is in high volume stream format. This causes inefficient memory usage.

Additionally, the conventional communication terminal must activate the broadcast modem each time it reproduces the broadcast data stored in the memory. This increases battery power consumption of the communication terminal.

Furthermore, it takes a long time for the communication terminal to send the stored broadcast data to a different communication terminal since the volume of the broadcast data is high. This results in a large communication service charge for the communication terminal to send the broadcast data. Moreover, the different communication terminal cannot reproduce the received broadcast data if it has no broadcast modem.

Therefore, there is a need for a method, communication terminal and system that facilitates storing and reproducing stream data for multimedia broadcasts such that terminals not having a broadcast modem can efficiently receive and reproduce the multimedia broadcasts. The present invention addresses these and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention is directed to a method, communication terminal and system for storing and reproducing multimedia broadcast stream data that substantially obviate one or more problems due to limitations and disadvantages of the related art. An object of the present invention is to provide a method, communication terminal and system for storing and reproducing multimedia broadcast stream data that allows a general mobile communication-only terminal having no broadcast modem for multimedia broadcasts to reproduce broadcast data using a mobile communication modem.

In one aspect of the present invention, a method for storing and reproducing broadcast data received in a communication terminal is provided. The method includes converting the received broadcast data to a moving image file and storing the moving image file, wherein the moving image file is a format that can be reproduced by a mobile communication modem.

It is contemplated that the format of the moving image file is one of avi, asf, dvix, mpeg, kg, gp, skm, lmp, wmv, wmv and xvid. It is further contemplated that the format of the moving image file is Moving Picture Experts Group (mp).

It is contemplated that the broadcast data comprises stream data either received from a broadcasting station when the communication terminal operates in broadcast mode or previously stored in memory. It is further contemplated that the format of the broadcast data is one of audio video interleaving (avi) and Moving Picture Experts Group (mp).

It is contemplated that converting the broadcast data to the moving image file comprises changing the file size of the broadcast data. It is further contemplated that converting the broadcast data to the moving image file comprises compressing the broadcast data to a smaller size.

In another aspect of the present invention, a method for storing and reproducing broadcast data in a communication terminal for broadcasts is provided. The method includes receiving broadcast data in stream format and converting the broadcast data to moving image data adapted for mobile communication.

It is contemplated that the method further includes decoding the moving image data and displaying the decoded moving image file. It is further contemplated that the method further includes storing the moving image data, decoding the stored moving image data and displaying the decoded moving image data

In another aspect of the present invention, a mobile communication terminal is provided. The terminal includes a mobile communication codec adapted to convert broadcast data to a moving image file, a mobile communication modem adapted to decode the moving image file when reproduction of the moving image file is requested and a display adapted to output the decoded moving image file from the mobile communication modem.

It is contemplated that the communication terminal further includes a memory that adapted to store the converted moving image file from the mobile communication codec. It is further contemplated that the mobile communication modem is further adapted to decode the moving image file stored in the memory. Preferably, the communication terminal further includes a broadcast modem adapted to store received broadcast data in a memory, decode the stored broadcast data and output the decoded broadcast data to the display.

In another aspect of the present invention, a communication system is provided. The system includes a transmitting-side communication terminal including a receiver adapted to receive broadcast data from a broadcasting station, a mobile communication codec adapted to convert the broadcast data to a moving image file, a memory adapted to store the moving image file and a transmitter adapted to transmit the stored moving image file and a receiving-side communication terminal including a receiver adapted to receive the moving image file from the transmitting-side communication terminal, a mobile communication modem adapted to decode the received moving image file and a display adapted to output the decoded moving image file from the mobile communication modem.

It is contemplated that the format of the moving image file is one of avi, asf, dvix, mpeg, kg, gp, skm, lmp, wmv, wmv and xvid format It is further contemplated that the format of the moving image file is Moving Picture Experts Group (mp).

It is contemplated that the format of the broadcast data is one of audio video interleaving (avi) and Moving Picture Experts Group (mp). It is further contemplated that the mobile communication codec is adapted to convert the broadcast data to the moving image file by changing the file size of the broadcast data. Preferably, the mobile communication codes is adapted to convert the broadcast data to the moving image file by compressing the broadcast data to a smaller size.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a block diagram of a communication terminal for storing and reproducing broadcast data according to the present invention.

FIG. 2 is a block diagram of a communication system for storing and reproducing broadcast data according to the present invention.

FIG. 3 is a flow chart of a method for storing and reproducing broadcast data according to the present invention.

### DETAILED DESCRIPTION OF THE INVENTION

Reference will now be made in detail to preferred embodiments of a method, communication terminal and system for storing and reproducing broadcast data according to the present invention, examples of which are illustrated in the accompanying drawings. Wherever possible, the same reference numbers will be used throughout the drawings to refer to the same or like parts.

The objects, features and other advantages of the present invention will be more clearly understood from the following detailed description taken in conjunction with the accompanying drawings. The configuration and operation of the embodiments of the present invention will be described with reference to the accompanying drawings. The configuration and operation of the present invention shown in the drawings and described hereinafter will be described in at least one embodiment, without limiting the spirit and scope of the present invention.

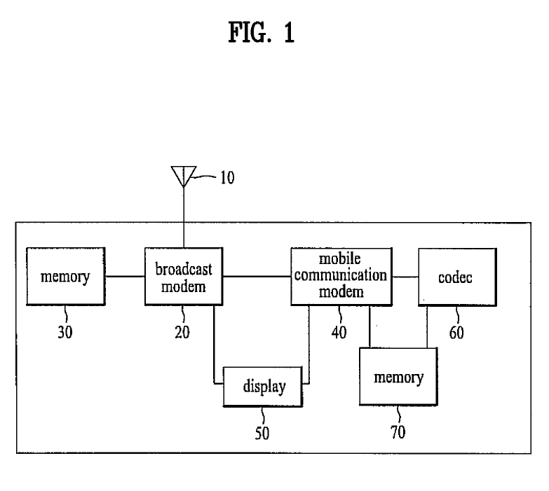

FIG. 1 is a block diagram of a communication terminal for storing and reproducing broadcast data according to the present invention. As illustrated in FIG. 1, the communication terminal includes an antenna 10, a broadcast modem 20, a memory 30 for the broadcast modem 20, a mobile communication modem 40, a mobile communication codec 60, a memory 70 and a display 50 that displays decoding results of the two modems 20 and 40.

The antenna 10 includes a tuner that receives and tunes high frequency multimedia broadcast data. The broadcast data is in stream format, either audio video interleaving (avi) or Moving Picture Experts Group 4 (mp4) format.

The broadcast modem 20 stores received broadcast data in the memory 30 or decodes the received broadcast data. The broadcast modem 20 then outputs the decoding result of the received broadcast data to the display 50.

When reproduction of broadcast data stored in the memory 30 is requested, the broadcast modem 20 decodes the broadcast data stored in the memory 30 and outputs the decoded broadcast data to the display 50, which displays broadcast content according to the decoding result, Preferably, the broadcast modem 20 decodes the broadcast data and outputs the decoded broadcast data to the display 50 when the communication terminal operates in broadcast mode.

The broadcast modem 20 transfers received broadcast data to the mobile communication modem 40. The mobile communication modem 40 converts the broadcast data received from the broadcast modem 20 using the mobile communication codec 60. The mobile communication codec 60 converts the input broadcast data to a format for reproduction by the mobile communication modem 40. Specifically, the mobile communication codec 60 converts the input broadcast data to a moving image file.

The moving image file is in a format for reproduction by the mobile communication modem 40. Typically, the moving image file is a signal format for decoding by mobile communication modems provided in communication terminals adapted only for mobile communication. For example, the moving image file is in either avi, asft dvix, MPEG, k3g, 3gp, skm, lmp4, wmv, wmv9 or xvid format. The MPEG format is preferably mp4 format.

The moving image file produced by the conversion performed by the mobile communication codec 60 is stored in the memory 70 of the mobile communication modem 40. The mobile communication modem 40 codes or decodes the mobile communication data.

More specifically, when reproduction of the moving image file produced by the conversion process is requested, the mobile communication modem 40 decodes the moving image file. Alternatively, when reproduction of a moving image file stored in the memory 70 of the mobile communication modem 40 is requested, the mobile communication modem 40 decodes the stored moving image file.

The mobile communication modem 40 outputs the decoded moving image file to the display 50. The input moving image file is displayed by the display 50.

In the above description, the mobile communication codec 60 converts input broadcast data to a different format. However, converting the broadcast data into a moving image file may include not only converting broadcast data into a moving image file of a different format, but also converting broadcast data into a moving image file of the same format.

Conversion into a moving image file of the same format is performed when the format of the broadcast data has been set to the same format as the moving image file. When converting into the same format, the mobile communication codec 60 changes the file size of broadcast data received by the broadcast modem 20 to a smaller file size.

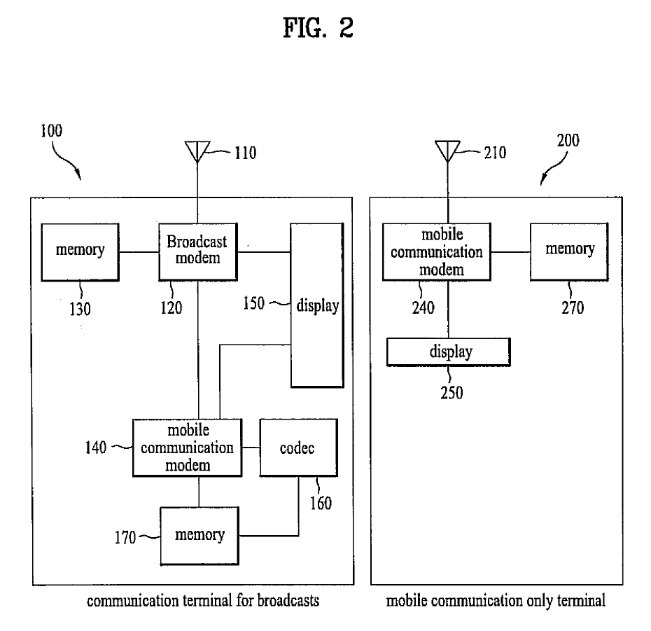

FIG. 2 is a block diagram of a communication system for storing and reproducing broadcast data according to the present invention. As illustrated in FIG. 2, the communication system according to the present invention includes a transmitting-side terminal 10 and a receiving-side terminal 200.

The following description assumes that the transmitting-side terminal 100 is a communication terminal according to the present invention as illustrated in FIG. 1 and the receiving-side terminal 200 is a mobile communication-only terminal that supports only mobile communication services. However, the receiving-side terminal 200 may also be a communication terminal according to the present invention as illustrated in FIG. 1.

Although the transmitting-side terminal 100 is described above with reference to FIG. 1, a more detailed description is given. The description focuses on the structure of the transmitting-side terminal 100 that converts received broadcast data to a moving image file and transmits the moving image file to another terminal, such as the receiving-side terminal 200 in the communication system according to the present invention. A description is also given of the configuration and operation of the receiving-side terminal 200 that receives a moving image file from the transmitting-side terminal 100 and reproduces the received moving image file.

The transmitting-side terminal 100, which receives and stores broadcast data from a broadcasting station, includes a broadcast modem 120, a memory 130 for the broadcast modem, a mobile communication codec 160, a memory 170 and a mobile communication modem 140. The transmitting-side terminal 100 further includes a transmitter 110 that transmits a moving image file stored in the memory 170 to the receiving-side terminal 200 when transmission of the stored moving image file is requested.

The mobile communication codec 160 converts broadcast data received through the broadcast modem 120 to a moving image file. The memory 170 stores the moving image file produced by the conversion process of the mobile communication codec 160. The mobile communication modem 140 controls the mobile communication codec 160 to perform signal conversion and store the converted data in the memory 170.

The receiving-side terminal 200 includes a receiver 210 that receives a moving image file from the transmitting-side communication terminal 100 and a mobile communication modem 240 that decodes a moving image file when reproduction of the moving image file is requested. The mobile communication modem 240 controls storage of a received moving image file in the memory 270. The receiving-side terminal 200 further includes a display 250 to display decoding results of the mobile communication modem 240.

The transmitting-side terminal 100 receives broadcast data (stream data) from a broadcasting station and stores the received broadcast data. The transmitting-side terminal 100 then converts the received broadcast data to a moving image file and stores the moving image file. Preferably, the transmitting-side terminal 100 stores either the received broadcast data or the moving image file in the memory 170. When the receiving-side terminal 200 receives a moving image file from the transmitting-side terminal 100, the receiving-side terminal stores the received moving image file in a memory.

When a user requests transmission of a specific moving image file, the transmitting-side terminal 100 reads the specific moving image file from the memory 170. The transmitting-side terminal 100 then transmits the requested moving image file to the receiving-side terminal 200.

When a user of the transmitting-side terminal 100 requests reproduction of a specific moving image file, the mobile communication modem 140 of the transmitting-side terminal decodes the specific moving image file. The specific moving image file may be either a moving image file produced by the conversion of received broadcast data or a moving image file stored in the memory after conversion.

The receiving-side terminal 200 stores the moving image file in the memory 270 after receiving it from the transmitting-side terminal 100. When the user requests reproduction of the stored moving image file, the mobile communication modem 240 of the receiving-side terminal 200 reads the moving image file from the memory 270 and decodes the moving image file.

When the user of the receiving-side terminal 200 requests reproduction of a moving image file immediately after receiving the moving image file from the transmitting-side terminal 100, the mobile communication modem 240 of the receiving-side terminal decodes the received moving image file. On the other hand, when the user requests reproduction of broadcast data after the transmitting-side terminal 100 receives the broadcast data, the broadcast modem 120 of the transmitting-side terminal decodes the broadcast data. After the transmitting-side terminal 100 or the receiving-side terminal 200 performs the decoding, the respective display 150 or 250 display broadcast content according to the decoding results.

In summary, the transmitting-side terminal 100 converts broadcast data received from a broadcasting station into a format, such as a moving image file, that can be reproduced by a communication terminal adapted only for mobile communication. The transmitting-side terminal 100 stores the conversion result, such as the moving image file, in the memory 170. At a user's request, the transmitting-side terminal 100 transmits the conversion result, such as the moving image file, to another communication terminal.

Preferably, the format of the broadcast data received from the broadcasting station is mp4. However, the broadcast data format is not limited to mp4. The moving image file produced by converting the broadcast data is in either avi, asf, dvix, mpeg (including mp4), k3g, 3gp, skm, lmp4, wmv, wmv9 or xvid format.

When the broadcast data and the moving image file are in the same format, the mobile communication codec 160 changes the file size of the broadcast data instead of converting the format of the broadcast data. For example, the mobile communication codec 160 compresses the file size of the broadcast data to produce a small-size file.

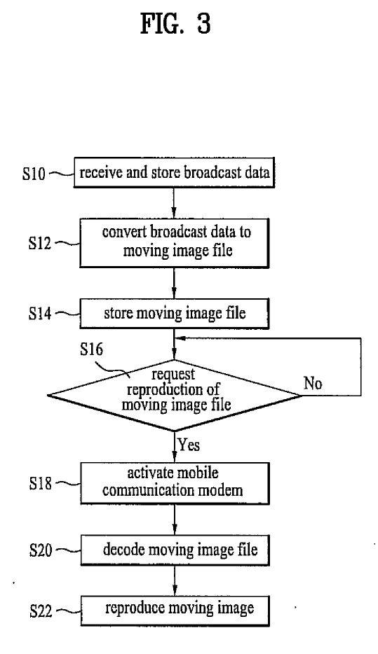

FIG. 3 is a flow chart of a method for storing and reproducing broadcast data according to the present invention. As illustrated in FIG. 3 and with further reference to FIG. 1, the communication terminal receives broadcast data (stream data) from a broadcasting station and stores the broadcast data in the memory 30 (S10). The broadcast modem 20 controls receiving and storing the broadcast data in the memory 30.

The broadcast modem 20 transfers the broadcast data to the mobile communication modem 40. Preferably, the broadcast modem 20 transfers the broadcast data to the mobile communication modem 40 immediately after receiving it from the broadcasting station. In some implementations, the broadcast modem 20 may transfer the broadcast data, which has been stored in the memory 30, to the mobile communication modem 40.

The mobile communication modem 40 converts the broadcast data received from the broadcast modem 20 to a moving image file using the mobile communication codec 60 (S12). The moving image file is in a format for reproduction by the mobile communication modems 40. The mobile communication codes 60 stores the moving image file produced by the conversion in its memory (S14).

When the user requests reproduction of the stored moving image file (S16), the mobile communication modem 40 is activated (S18) to read and decode the stored moving image file (S20). The stored moving image file is then reproduced via the display 50 (S20). Thus, broadcast content according to the decoded moving image file is displayed on the display 50.

If the user later requests transmission of the stored moving image file to a different communication terminal, the mobile communication modem 40 reads and transmits the stored moving image file to the different communication terminal. The different communication terminal receives the moving image file and decodes it using its modem. It is assumed that the different communication terminal is a communication terminal adapted for mobile communication only.

The mobile communication modem 40 of the present invention generally may perform modulation/demodulation for signal reception/transmission. The mobile communication modem 40 may have a codec (not shown) for reproducing files. Additionally, the mobile communication modem 40 may operate as a central processing unit to control functions of the communication terminal. Furthermore, the mobile communication codec 60 may be provided as part of the mobile communication modem 40 in an alternative embodiment to that illustrated in FIG. 2.

As is apparent from the above description, the present invention facilitates conversion of broadcast data received in stream format for multimedia broadcasts to a format, such as a moving image file, which is supported by a mobile communication codec in a mobile communication-only terminal, and stores the moving image file. In this way, the broadcast content is reproduced using the moving image file that has a smaller size than the broadcast stream data. Therefore, the present invention reduces a terminal's battery power consumption.

Additionally, the present invention facilitates converting broadcast data to a moving image file that can be decoded by a mobile communication modem. Therefore, reproducing broadcast content corresponding to the broadcast data without activating a broadcast modem is possible, such as when no broadcast modem is provided.

Furthermore, the present invention facilitates converting broadcast data to a moving image file that has a smaller size than the broadcast data and transmitting the stored moving image file to a mobile communication-only terminal. Therefore, it takes less time to transmit the broadcast data, thereby reducing communication charges for the transmission.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for storing and reproducing broadcast data received in a communication terminal, the method comprising:
converting the received broadcast data to a moving image file; and
storing the moving image file,
wherein the moving image file is a format that can be reproduced by a mobile communication modem.

2. The method according to claim 1, wherein the format of the moving image file is one of avi, asf, dvix, mpeg, k3g, 3gp, skm, lmp4, wmv, wmv9 and xvid.

3. The method according to claim 2, wherein the format of the moving image file is Moving Picture Experts Group 4 (mp4).

4. The method according to claim 1, wherein the broadcast data comprises stream data either received from a broadcasting station when the communication terminal operates in broadcast mode or previously stored in memory.

5. The method according to claim 4, wherein the format of the broadcast data is one of audio video interleaving (avi) and Moving Picture Experts Group 4 (mp4).

6. The method according to claim 1, wherein converting the broadcast data to the moving image file comprises changing the file size of the broadcast data.

7. The method according to claim 6, wherein converting the broadcast data to the moving image file comprises compressing the broadcast data to a smaller size.

8. A method for storing and reproducing broadcast data in a communication terminal for broadcasts, the method comprising:
receiving broadcast data in stream format; and
converting the broadcast data to moving image data adapted for mobile communication.

9. The method according to claim 8, further comprising:
decoding the moving image data; and
displaying the decoded moving image file.

10. The method according to claim 8, further comprising:
storing the moving image data;
decoding the stored moving image data; and
displaying the decoded moving image data

11. A communication terminal, comprising:
a mobile communication codec adapted to convert broadcast data to a moving image file;
a mobile communication modem adapted to decode the moving image file when reproduction of the moving image file is requested; and
a display adapted to output the decoded moving image file from the mobile communication modem.

12. The communication terminal according to claim 11, further comprising a memory that adapted to store the converted moving image file from the mobile communication codec.

13. The communication terminal according to claim 12, wherein the mobile communication modem is further adapted to decode the moving image file stored in the memory.

14. The communication terminal according to claim 11, further comprising a broadcast modem adapted to store received broadcast data in a memory, decode the stored broadcast data and output the decoded broadcast data to the display.

15. A communication system, comprising:
a transmitting-side communication terminal comprising a receiver adapted to receive broadcast data from a broadcasting station, a mobile communication codec adapted to convert the broadcast data to a moving image file, a memory adapted to store the moving image file and a transmitter adapted to transmit the stored moving image file; and
a receiving-side communication terminal comprising a receiver adapted to receive the moving image file from the transmitting-side communication terminal, a mobile communication modem adapted to decode the received moving image file and a display adapted to output the decoded moving image file from the mobile communication modem.

16. The communication system according to claim 15, wherein the format of the moving image file is one of avi, asf dvix, mpeg, k3g, 3gp, skm, lmp4, wmv, wmv9 and xvid format.

17. The communication system according to claim 16, wherein the format of the moving image file is Moving Picture Experts Group 4 (mp4).

18. The communication system according to claim 15, wherein the format of the broadcast data is one of audio video interleaving (avi) and Moving Picture Experts Group 4 (mp4).

19. The communication system according to claim 15, wherein the mobile communication codec is adapted to convert the broadcast data to the moving image file by changing the file size of the broadcast data.

20. The communication system according to claim 19, wherein the mobile communication codec is adapted to convert the broadcast data to the moving image file by compressing the broadcast data to a smaller size.
